(19) United States
(12) Patent Application Publication
(10) Pub. No.: US 2010/0061650 A1
(43) Pub. Date: Mar. 11, 2010

(54) Method And Apparatus For Providing A Variable Filter Size For Providing Image Effects

(76) Inventors: Barinder Singh Rai, Surrey (CA); Jiliang Song, Surrey (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 12/205,531

(22) Filed: Sep. 5, 2008

(51) Int. Cl. G06K 9/40

(52) U.S. Cl. 382/264

(57) ABSTRACT

A de-noising circuit for filtering image data is provided. The de-noising circuit includes a buffer for storing a portion of the image data and detail detection circuitry configured to determine a filter size. The determined filter size is then applied to a captured image to improve the quality of the image by smoothing transitions within the image. To determine an appropriate filter size, a comparison is made between a sum of differences between a center pixel value within a first pixel matrix size and all of the remaining values within the first pixel matrix size, and a threshold range value. The threshold range value corresponds to a specific filter size. Various filter sizes are provided allowing for different smoothing effects, depending on the filter size used. Selection circuitry configured to select between either unfiltered data, or filtered data using one of various sizes of filters based on a selection signal from the detail detection circuitry is included.

### BACKGROUND

Many digital cameras, especially the lower quality digital cameras associated with cell phones or other portable electronic devices, do not produce very clear images of the pictures they capture. One reason digital images are often of a low quality is because of the use of very small lenses on the portable devices due to physical space constraints. Smaller lenses inherently allow less light into the lens than larger ones. Less light results in a larger noise to signal ratio which produces a low quality image. The lack of a flash for the camera also introduces noise into the image data. Other factors for poor image quality include the digital sampling rate of the camera, the use of inexpensive lenses to keep the cost of the device low, and the limited computing resources of the portable device.

What is needed is a method and system that improves the quality of digital images captured through portable devices having limited computing resources.

### SUMMARY

Broadly speaking, the present invention fills these needs by providing a denoising circuit and method. It should be appreciated that the present invention can be implemented in numerous ways, including as a process, an apparatus, a system, a device, or a method. Several inventive embodiments of the present invention are described below.

In one embodiment, a method for providing a variable filter size to improve picture quality is included. The method initiates with receiving captured image data. The method includes comparing a value representing a center pixel of a pixel matrix to each pixel value within the pixel matrix and summing differences between the center pixel value and each pixel value. The method includes determining a size of a region of the pixel matrix to blur according to the summed differences between the center pixel value and each remaining pixel value. The method includes applying a blurring function to the region.

In another embodiment, an apparatus capable of blurring regions of captured image data is provided. The apparatus includes an analyzer configured to analyze pixel matrix values representing the captured image data to determine if the pixel matrix represents an image data background region or an image data foreground region. Also included are at least two different size filters. A logic circuit is configured to determine if any of the at least two filters needs to be applied to the pixel matrix, and if so, which filter to apply. Selection circuitry configured to select between the blurred image data and the subset of the portion of the image data based on a selection signal from the detail detection circuitry is included.

The advantages of the present invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, where like reference numerals designate like structural elements.

FIG. 1 is a block diagram that illustrates a system for providing a variable filter size that may be used to implement the invention.

FIG. 2 is a block diagram of the de-noise unit, in accordance with one embodiment of the present invention.

FIG. 3 is a view of a captured image with corresponding filter sizes, in accordance with one embodiment of the invention.

FIG. 4A is a simplified view of a pixel matrix that has not yet entered an edge area, or transition area, in accordance with one embodiment of the present invention.

FIG. 4B is a simplified view of a 25×25 pixel matrix that has just entered an edge area, or transition area, and also a 19×19 pixel matrix that has not yet entered an edge or transition area, in accordance with one embodiment of the invention.

FIG. 5 shows a representation of the detail detector and possible values stored in a register array, in accordance with one embodiment of the invention.

FIG. 6 is a flow chart showing a method for providing a variable filter size, in accordance with one embodiment of the present invention.

### DETAILED DESCRIPTION

An invention is described for methods, apparatuses, and systems for providing a variable filter size for providing image effects. It will be obvious, however, to one skilled in the art, that the present invention may be practiced without some or all of these specific details. In other instances, well known process operations have not been described in detail in order not to unnecessarily obscure the present invention.

The embodiments described herein provide methods, apparatuses, and systems for filtering digital image data with variable size filters to smooth any noise in the image data. In one embodiment, an amount of blur is applied to a subset of a pixel matrix to improve the quality of a captured image. In one embodiment various size pixel matrices are chosen as filters and the selected filters are then applied to a captured image to produce different image effects. For instance, in one embodiment several different filter sizes are available, each filter size being a subset of the previous filter size. That is, each filter size is a pixel matrix that is a portion of the previous pixel matrix. In this way, a blur filter may be chosen to blur either the whole image or a portion of the image. In another embodiment, the choice between different filter sizes is a user selectable feature.

In one embodiment, threshold ranges may be used with the embodiments described herein. A large filter may be selected as a first filter. A comparison is made between a center pixel value and the remaining pixel values within an area encompassed by the first filter. The result of the comparison is then compared to a threshold value. In one embodiment, if the result of the comparison is less than a threshold value, then the first filter size is used to filter the image. However, if the comparison result is more than the threshold value, then a second filter size is chosen, where the second filter size is smaller than the first filter size. In one embodiment the process repeats itself. That is, if a second filter size was chosen, then another comparison is performed, i.e. the center pixel value of the second filter size is compared to the remaining pixel values within the second filter size matrix. The result of this second comparison is compared to a second threshold value, and a decision is made whether to use the second filter size to filter the image, or whether to use yet another smaller third filter size. It should be appreciated that this process may be performed one time with only a single filter, wherein a decision based on the comparison would be to either apply the first filter or not use any filter at all. In an alternative embodiment, as many consecutive filters as desired could be used, e.g., 2 filter sizes, three filter sizes, and so on may be used. As an example, in one embodiment a first filter size using a 25×25 pixel matrix (25 rows×25 columns) could be chosen as a first filter size, and a second filter could be chosen as a subset of the first filter size. For instance, in one embodiment a second filter size using a 9×9 pixel matrix could be chosen. It should be apparent to those ordinarily skilled in the art that the foregoing are only examples of pixel matrix sizes, and many other sizes may be chosen. By selecting an appropriate filter size from a variety of filter sizes it is possible to improve the image quality while at the same time preserving a substantial portion of the detail captured in the original image.

As will be explained in more detail below, in one embodiment, an apparatus for providing a variable filter size for providing image effects may include image capture circuitry, e.g., a graphics processor. The image capture circuitry and graphics processor capture an image and process captured image data in the form of pixels. De-noising circuitry communicates with the image capture circuitry and the graphics processor. The de-noising circuitry may include a line buffer for storing the captured image data, detail detection circuitry configured to calculate a difference between a center pixel value of a portion of captured image data and a remainder of pixel values within the portion of captured image data. Also included are variable filter sizes, each filter size configured to apply an amount of blur to a subset of a portion of image data.

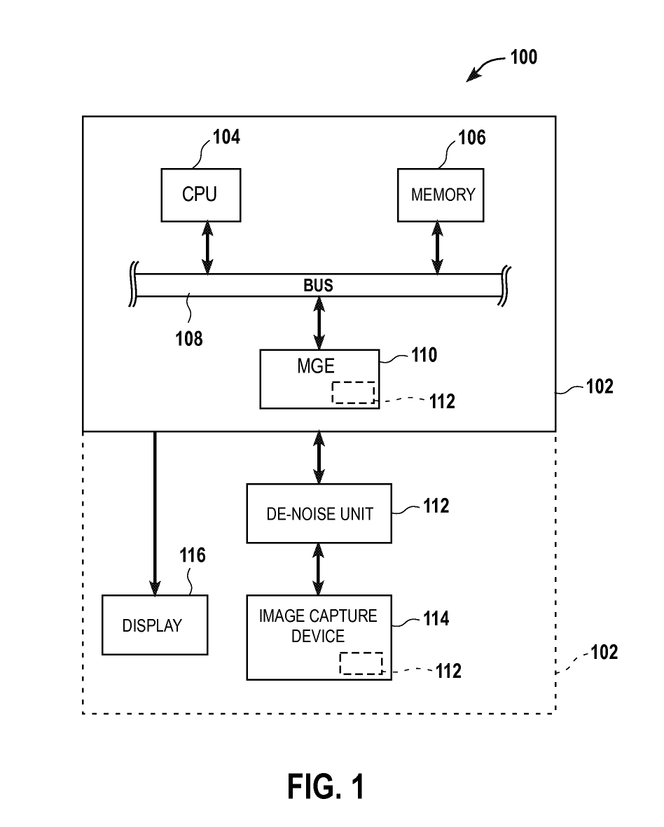

FIG. 1 is a block diagram that illustrates a system 100 for providing a variable blur that may be used to implement the invention. As shown in FIG. 1, a computing unit 102 includes a Central Processing Unit (CPU) 104, a memory 106, a bus 108, and a Mobile Graphics Engine (MGE) 110. Bus 108 provides a communication route through which data can travel between CPU 104, Memory 106, and MGE 110. Bus 108 may be implemented by any means that allow the functional units of computing unit 102 to communicate with each other. Computing unit 102 may be implemented on a Personal Computer (PC), a cell phone, a web tablet, a personal PC, a Personal Digital Assistant (PDA), a laptop, etc., each of which includes image capture capability. Although the foregoing are examples, it should be appreciated that any computing device, either portable or non-portable, may be used to implement the invention, even though the embodiments described herein are described with reference to a limited computing resource and battery powered device.

Computing unit 102 is in communication with image capture device 114 through a de-noise unit 112. It should be noted that image capture device 114 may be incorporated into a charged coupled device (CCD) or complementary metal oxide semiconductor (CMOS) chip. Computing unit 102 receives image data from the image capture device 114 via the de-noise unit 112 after a determination by de-noise unit 112 whether or not the image should be filtered. The image capture device 114 may be a stand-alone unit, or may be integrated into the computing unit 102. De-noise unit 112 may be constructed of discrete circuitry, logic gates, etc., and may be integrated onto computing device 102 or image capture device 104. That is, de-noise unit 112 may be a functional block incorporated into MGE 110, as illustrated in FIG. 1. One skilled in the art will appreciate that MGE 110 may be referred to as a graphics processor. In an alternative embodiment, de-noise unit 112 may be integrated into image capture device 104. Thus, the location of de-noise unit 112 is a design choice as many alternatives are possible. Display 116 may be a computer monitor, a Liquid Crystal Display (LCD), or a Thin Film Transistor display of computing device 102.

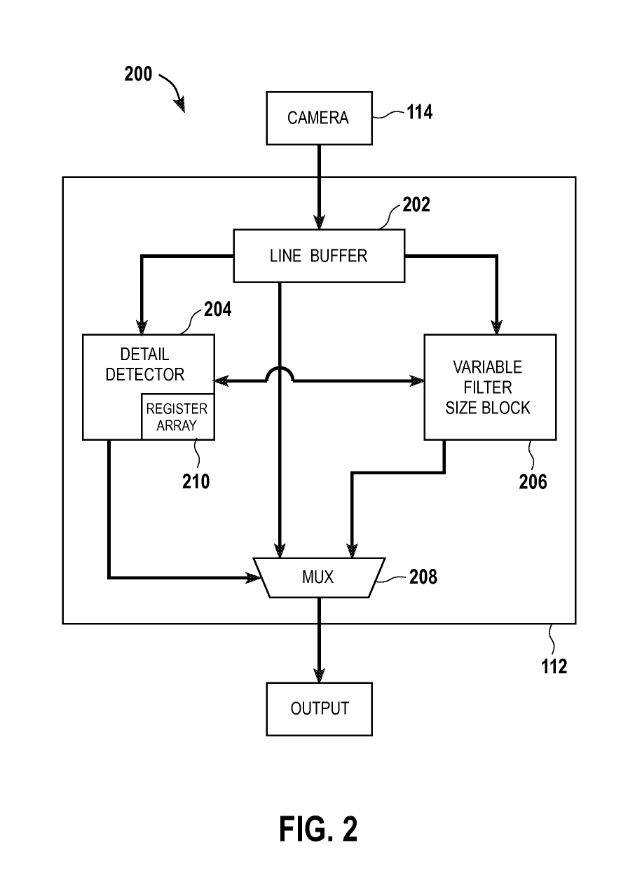

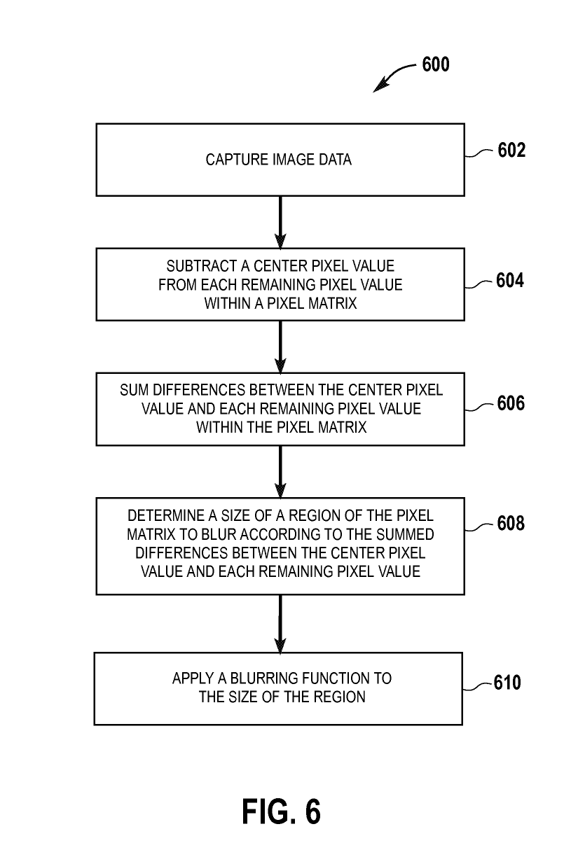

FIG. 2 is a block diagram 200 of the de-noise unit 112, in accordance with one embodiment of the present invention. De-noise unit 112 contains circuitry that analyzes the image data from image capture device 114, determines if portions of a captured image should be filtered to improve the quality of the image, and then passes on either filtered or unfiltered image data to computing unit 102 which will control the display of the image data. A line buffer 202 is configured to receive a portion of the captured image data from the image capture device 114. Line buffer 202 is a memory region used to hold a specific amount of image data, which may be a portion of the entire frame of image data to be displayed, in one embodiment. In one exemplary embodiment, line buffer 202 is 25 rows deep to accommodate data from a first filter size of 25 rows×25 columns (25×25) pixel matrix. Of course, this is only one example of a matrix size and is not meant to be limiting, as any suitable matrix size may be used. Line buffer 202 provides data to the detail detector 204, variable filter size block 206, and also to multiplexer 208. Detail detector 204 contains circuitry configured to calculate a difference between a center pixel value of a portion of captured image data and a remainder of pixel values within the portion of captured image data. Detail detector 204 includes a register array 210. Register array 210 stores a plurality of threshold range values corresponding to respective coefficients. FIG. 6 further describes the relationship between threshold ranges and respective coefficients in more detail.

Detail detector 204 is in communication with variable filter size block 206 and multiplexer 208. Detail detector 204 includes circuitry configured to determine whether or not the image data from line buffer 202 is presented as filtered or unfiltered data. In this embodiment, this determination is made by comparing the sum of the differences calculated within a chosen matrix to a corresponding threshold value stored in register array 210. If the comparison of the sum of the differences and the threshold value indicates that the portion of the image data represented by the pixel matrix does not need to be filtered, then detail detector 204 instructs the multiplexer 208 via a control signal to output non-filtered image data, i.e., the data from line buffer 202. If detail detector 204 determines that the image data needs to be filtered, then detail detector 204 outputs a control signal selecting image data output from variable filter size block 206. The detail detector 204 also instructs variable filter size block 206 on which filter size stored in register array 210 to select to be applied to the image data from detail detector 206. For instance, in one embodiment the sum of the differences (x) between a center pixel value and the remaining values in a chosen pixel matrix is calculated in detail detector 204. The sum is then compared to a threshold value stored in register array 210. In one embodiment, threshold ranges as they correspond to various filter sizes may be chosen as illustrated in Table 1.

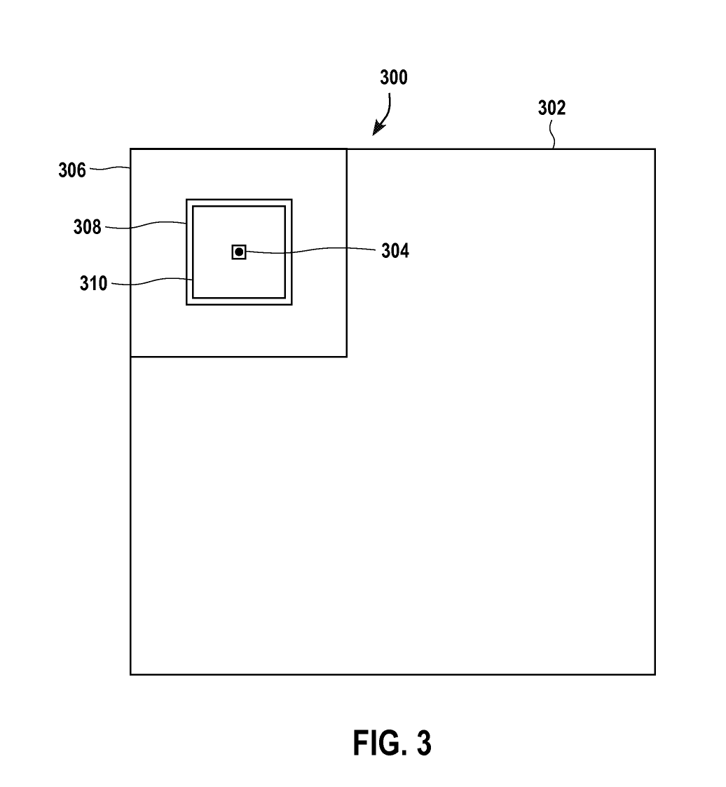

FIG. 3 is a view of a captured image 302 with corresponding filter sizes applied thereto, in accordance with one embodiment of the invention. In one embodiment, matrix 306 is a 25×25 matrix, i.e. the matrix is composed of 25 pixels across (a row of pixels) and 25 pixels down (a column of pixels). In this embodiment the center pixel 304 is the actual center of the 25×25 matrix (i.e. the center is 13 rows across and 13 rows down). Although the center pixel 304 is the actual center pixel of the 25×25 pixel because the matrix contains an odd number of rows and an odd number of columns resulting in an odd number of pixels in the matrix, this is not meant to be limiting. That is, if there are an even number of pixels which form the pixel matrix there will not be an actual center. In that case, when the matrix is made up of an even number of pixels (or even if there are an odd number of pixels as in our 25×25 example), any pixel in the matrix may be chosen as the center pixel 304, also referred to as a reference pixel, as long as this pixel location is chosen consistently for each successive matrix. Once center pixel 304 is chosen, the absolute value of the difference between the center pixel value 304 and all the remaining pixel values in the 25×25 matrix 306 are added together to get a sum of the differences (x).

In one embodiment, if x is below a predetermined threshold range, then the 25×25 matrix 306 is applied as a filter. If x is above the predetermined threshold range, then a second filter size is chosen. In one embodiment, an 11×11 pixel matrix 308 is chosen as a second filter size. Then, the absolute value of the differences between the center pixel value 304 and all the remaining pixel values in the 11×11 pixel matrix 308 are added together to get a sum of the differences (x). Next, x is compared to a threshold value and as in the previous example with the 25×25 matrix, the 11×11 pixel matrix 308 may be applied as a filter if x is below a pre-determined threshold value. If x is more than a pre-determined threshold value then a third filter size may be chosen. In one embodiment, the third filter size may be a 9×9 pixel matrix 310. Once a third filter size is chosen, a determination as whether to apply the third filter size or use another filter size can be made similar to the description above for the first and second filter sizes. It should be appreciated by those ordinarily skilled in the pertinent art that the filter sizes and the number of filters (e.g. first, second, and third) given above, are exemplary only and that many other filter sizes and a different number of filters may ultimately used in the manner specified above. In on embodiment, the value of x may be compared to determine if the value is within a certain range to select an appropriate filter size according to Table 1. An example of how threshold values may correspond to filter sizes in one embodiment is illustrated below in Table 1.

TABLE 1

| Exemplary | Exemplary |
|---|---|
| Threshold Ranges | Filter Sizes |
| x < 100 | 25 × 25 |
| 100 ≦ x < 200 | 19 × 19 |
| 200 ≦ x < 300 | 11 × 11 |
| 300 ≦ x < 400 | 9 × 9 |
| 400 ≦ x ≦ 500 | 3 × 3 |
| x > 500 | Do not filter. |

The threshold ranges correspond to an amount of transition or detail is present in the pixel matrix, e.g., whether a selected region of the pixel matrix is a transition region. Where the sum of differences (x)<100, the region is classified as not having a transition or edge, i.e., there is not a lot of detail in the picture. Therefore, a large filter may be selected which results in a relatively large amount of filtering (blurring) applied to the region. In one embodiment, the filter sizes start out large, e.g. a 25×25 filter is selected, and then each successive matrix size gets smaller and smaller as the corresponding threshold range gets larger. Filtering may be accomplished by comparing a center pixel value in a chosen filter size pixel matrix, summing up the absolute values of the differences between the center pixel value and all the other pixel values in the chosen matrix, and then dividing by the total number of pixels in the matrix to get an average pixel value. Then, the average pixel value may be used to represent the value of all the pixels in the pixel matrix. If the sum of differences (x)>500, then in order to preserve as much of the detail as possible, no filtering (blurring) is applied to that region, i.e., no averaging takes place and the original pixel matrix values are used when displaying the image. It should be appreciated by those of ordinary skill in the art that the threshold ranges and filter sizes given in Table 1 are only one exemplary embodiment, and many other values are possible. Thus, the exemplary ranges in Table 1 are not meant to be limiting.

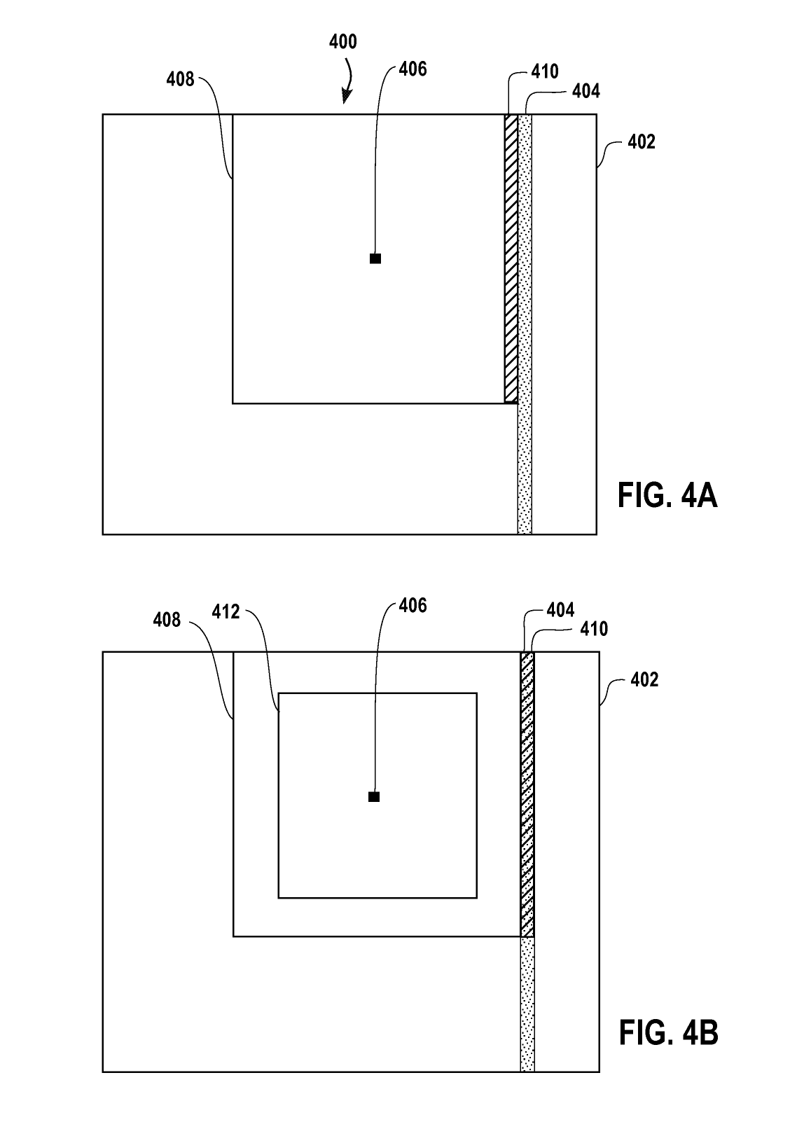

FIG. 4A is a simplified view 400 of a pixel matrix 408 which has not yet entered an edge area, or transition area 404, in accordance with one embodiment of the present invention. FIG. 4A has a 25×25 pixel matrix 408 with a pixel center 406. In this embodiment the far right column of 25 pixels 410, as well as the remaining pixels within the 25×25 pixel matrix, is completely composed of a background area of the image 402 and has not yet entered a transition area 404 of image 402. That is, the pixel values are similar in value for each of the pixels within matrix 406. In this embodiment, a comparison between the center pixel 406 and all the remaining pixels in the 25×25 pixel matrix 408 would result in a sum of differences equaling zero or a relatively low value. In this embodiment, therefore, a relatively large amount of blurring could be applied to 25×25 matrix 408 without any significant loss of detail when displaying the resulting blurred image. A transition area, in one embodiment, is any area where the image is changing from a background area to an area of some detail. It should be appreciated by those skilled in the pertinent art that the technique described herein works for both black and white images, as well as for colored images due to the relative comparison of pixel values.

FIG. 4B illustrates a 25×25 pixel matrix 408 with a pixel center 406 and a second pixel matrix, a 19×19 pixel matrix 412, that has the same center 406. The far right column 410 of 25×25 pixel matrix 408 has entered a transition area 404 of image 402. A comparison between the center pixel 408 and all the remaining pixels in the 25×25 pixel matrix 408 would result in a sum of differences equaling a value greater than the value from FIG. 4A. Therefore, a next filter size, for example filter 412 may be selected based on a comparison to a threshold level or where the result falls within the threshold ranges of a Table such as Table 1. The threshold levels/ranges allow graduated levels of filtering to be applied to the image depending on how much detail there is in the matrix area of the image, as represented by the sum of differences. It should be appreciated that a comparison between the sum of differences between the center pixel value 406 and all of the remaining pixel values in the 19×19 pixel matrix 412 can be compared to a threshold level to determine if yet another comparison should be done with a new filter size. A new, or smaller filter size than the 19×19 pixel matrix 412 could be chosen in one embodiment. Alternatively, based on the comparison using the 19×19 pixel matrix 412, the 19×19 pixel matrix 412 could itself be used to filter the captured image 402. In one embodiment, multiple Tables, similar to Table 1, may be used for each filter size. This process can be repeated as many times as desired with different size filters in one embodiment. It should be appreciated that the process described above provides moves across the rows of the image by advancing one column at a time from left to right and then returning to the left hand side and moving down one row, and so on, in a rasterization pattern. In addition, in one embodiment, in order to account for the corner pixels for filtering when the pixel matrix is a 9×9 and the reference pixel is the center pixel, the four rows under the center pixel can be translated to correspond to the rows above the first row. That is, the bottom four rows can be given row numbers −1 through −4, and the same can be done with the last four columns to essentially translate the 9×9 matrix so that the center is the first pixel in the top left hand corner. Alternatively, a border may be applied to around the image data. Similar techniques can be applied to filter sizes larger or smaller than the 9×9 filter size.

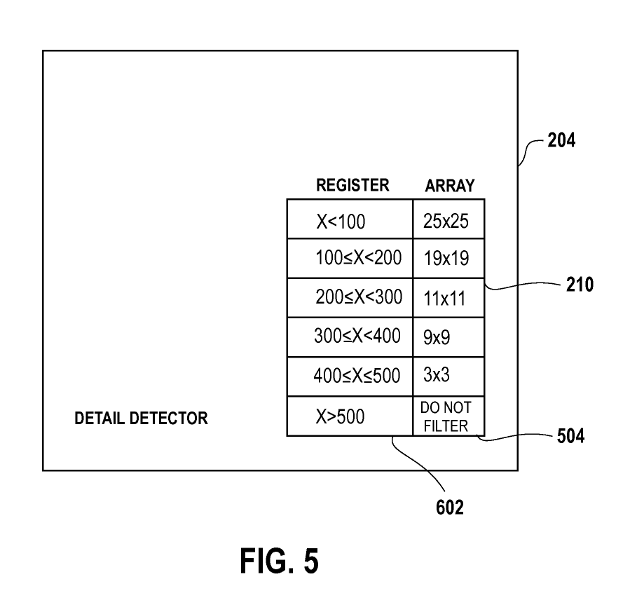

FIG. 5 shows a representation of detail detector 204 and possible values stored in a register array 210, in accordance with one embodiment of the present invention. In one embodiment, column 502 of register array 210 represents threshold range values stored in the registers, and column 504 represents filter sizes. For instance a filter size of 19×19 as shown in column 504, would represent a 19×19 pixel matrix to be used as a filter. In this embodiment (x) represents the sum of differences between a center pixel value and the remaining pixel values in a 25×25 pixel matrix. For example, if a comparison of the center pixel value to the remaining pixel values in the 25×25 pixel matrix resulted in a sum of differences of x=350, then a 9×9 pixel matrix would be chosen to filter a captured image because an x of 350 corresponds to a threshold range of 300≦x≦400, as shown in column 502 of register array 210 which contains threshold values. As mentioned above, register array 210 is an exemplary array and the exemplary arranges and coefficient values are not meant to be limiting in either the size of the ranges or the number of ranges.

FIG. 6 is a Flow Chart showing a method for providing a variable filter size, in accordance with one embodiment of the present invention. Flow chart 600 initiates with operation 602 where images are captured through an image capture device, e.g. a digital camera or other electronic image capturing device. It should be understood by those skilled in the art that the methods described herein may be extended to any image data represented in electronic form. For example, a non-electronic image such as a photograph may be converted into electronic form through a scanner, and the embodiments described herein may be applied to the electronic representation. The method then advances to operation 604 where a value representing a center pixel or reference pixel is compared to every other value in the pixel matrix. In one embodiment a pixel matrix size is selected in operation 604 and the pixel values of the matrix are stored. A line buffer or other storage element may be used for this purpose. A pixel matrix is a subset of the image data and consists of a selected number of rows and columns of pixels of the image data. Also in operation 604, a reference pixel is chosen, and in one embodiment the reference pixel may be a center pixel. Even if there is an actual center in the matrix, as previously explained above in the description of FIG. 3, any pixel in the matrix may be designated as the reference pixel. In one embodiment, a 25×25 matrix may be chosen. A 25×25 matrix consists of 25 pixels across the image (a row of pixels) and 25 pixels down the image (a column of pixels). In this embodiment, any pixel in the captured image may be selected as a starting point for the matrix that accommodates the 25×25 pixel matrix. It should be noted that the number of rows chosen does not have to be the same as the number of columns chosen, i.e. the matrix does not have to be square. In operation 604 the value representing the center pixel of the pixel matrix is compared to every other pixel value within the matrix by calculating the absolute value of the difference between the center pixel value and each other pixel value within the matrix. The comparing is done sequentially in one embodiment. That is, the center pixel value is compared to one other pixel value in the pixel matrix and then the center pixel value is compared to another pixel value in the pixel matrix, and so on until the center pixel value has been compared to every other pixel value within the matrix. However, it should be appreciated by those ordinarily skilled in the art that the individual comparisons may be accomplished as parallel operations.

From operation 604, the method proceeds to operation 606 where the differences between the value of the center pixel and every other pixel calculated in operation 604 are summed. It should be appreciated that operations 604 and 606 may be executed through hardware. That is, logic gates, e.g., adders, subtractors, comparators, and other known logic gates may be used to execute the operations described herein. Of course, the embodiments described herein may be executed through computer code stored within a memory also. From operation 606, the method proceeds to operation 608 where a size of a region of the pixel matrix to blur is determined according to the summed differences between the center pixel value and each remaining pixel value in the pixel matrix.

In one embodiment, blurring is accomplished by averaging pixel values within the selected pixel matrix. Determining a size of a region of the pixel matrix to blur corresponds to selecting a filter size, that is, a pixel matrix size to be used to filter a portion of the captured image. In one embodiment, filter sizes may be chosen as the following pixel matrix sizes; 25×25, 19×19, 11×11, 9×9, and 3×3. Each one of these filter sizes corresponds to a threshold value or range (see Table 1 above for an example). Of course these matrix sizes are not meant to be limiting, as any suitable matrix size may be utilized.

In operation 610, blurring is accomplished by averaging the pixel values within the selected filter size (pixel matrix) to remove some of the noise associated with digital images. In one embodiment, blurring is accomplished by averaging pixel values within the selected pixel matrix. This technique of blurring is a way of removing some of the noise associated with electronic images to smooth out portions of the image. Averaging is only one example of a blurring technique, many other blurring techniques as they apply to captured images are known by those skilled in the art. It should be appreciated that the filter sizes may be reduced as the pixel matrix begins encountering image detail regions, as discussed above. Likewise, the filter size may also be increased as the pixel matrix begins moving outside of image detail regions. Thus, the filter size may decrease from a 25×25 matrix to a 19×19 matrix and so on to a 9×9 or 3×3 matrix based on the sum of differences value and where that value falls within the threshold range of a corresponding table. Thereafter, the filter size can increase from a smallest filter size or no filtering systematically to a largest size filter as the sum of differences value changes in a manner indicating less detail in the pixel matrix.

Although a few embodiments of the present invention have been described in detail herein, it should be understood, by those of ordinary skill, that the present invention may be embodied in many other specific forms without departing from the spirit or scope of the invention. Therefore, the present examples and embodiments are to be considered as illustrative and not restrictive, and the invention is not to be limited to the details provided therein, but may be modified and practiced within the scope of the appended claims.

1. A method for blurring regions of captured image data with filters having variable sizes, comprising:
identifying a pixel matrix;
identifying a reference pixel within the pixel matrix;
identifying remaining pixels, which are pixels remaining within the pixel matrix after excluding the reference pixel;
calculating differences between a reference pixel value of the reference pixel and each remaining pixel value of each remaining pixel;
summing the differences;
selecting a size of a region of the pixel matrix to blur according to the sum of the differences;
applying a blurring function to the size of the region; and
outputting the image data after applying the blurring.

2. The method of claim 1, wherein selecting a size of a region of the pixel matrix to blur includes,
comparing the sum of the differences to a plurality of threshold ranges;
identifying one of the plurality of threshold ranges associated with the sum of the differences; and
selecting the size of the region associated with the identified one of the plurality of ranges.

3. The method of claim 1, further comprising:
moving the pixel matrix within the image data;
identifying a transition region within the moved pixel matrix;
identifying a next size of the region to blur, the next size of the region being smaller than the size of the region due to presence of the transition region in the pixel matrix.

4. The method of claim 1, wherein applying a blurring function to the size of the region includes,
averaging pixel values within the region.

5. The method of claim 1, wherein the size of the region is smaller than a size of the pixel matrix.

6. The method of claim 5, wherein an average of the size of the region is calculated prior to selecting the size of the region of the pixel matrix to blur.

7. The method of claim 3, further comprising:
successively moving the pixel matrix in a rasterization pattern within the image data; and
selecting different size regions to blur for corresponding movements of the pixel matrix based on presence of transition regions within the pixel matrix.

8. A de-noising circuit for filtering image data, comprising:
a buffer for storing a portion of the image data;
detail detection circuitry configured to determine a filter size to be applied to the portion of the image data;
a filter size block configured to average pixel values according to the filter size; and
selection circuitry configured to select between the average of the pixel values and values of the image data from the buffer based on a selection signal from the detail detection circuitry.

9. The de-noising circuit of claim 8, wherein the selection circuitry is a multiplexer receiving input from the buffer, the detail detection circuitry, and the filter size block.

10. The de-noising circuit of claim 8, wherein the detail detection circuitry includes a register array having a plurality of threshold ranges stored therein, the register array further includes filter sizes associated with each of the plurality of threshold ranges.

11. The de-noising circuit of claim 8, wherein a depth of the buffer equals one of a number of rows or a number of columns of the filter size.

12. The de-noising circuit of claim 8, wherein the de-noising circuit is integrated onto a graphics controller.

13. The de-noising circuit of claim 10, wherein the register array includes a plurality of tables associating filter sizes with threshold ranges.

14. A portable device, comprising:
image capture circuitry;
a graphics processor; and
de-noising circuitry in communication with the image capture circuitry and the graphics processor, the de-noising circuitry includes,
a line buffer configured to receive a portion of captured image data from the image capture circuitry;
detail detection circuitry configured to calculate differences between a reference pixel value of the portion of captured image data and a plurality of remainder pixel values within the portion of captured image data, and configured to select a filter size; and
a filter size block configured to apply a blur level to the pixel values of the portion of captured image data through the filter size.

15. The portable device of claim 14, wherein the detail detection circuitry includes a register array containing a set of threshold ranges.

16. The portable device of claim 15, wherein the register array includes filter sizes corresponding to each of the set of threshold ranges.

17. The portable device of claim 14, wherein the output of the detail detection circuitry is a selection signal selecting between pixel values of the data in the line buffer and pixel values to which the blur level has been applied.

18. The portable device of claim 14, wherein the line buffer has a depth equal to one of a number of rows or a number of columns of the filter size.

19. The portable device of claim 14, wherein the detail detection circuitry is configured to communicate with the filter size block and a multiplexer, the multiplexer configured to select between output of the line buffer and the filter size block based on output from the detail detection circuitry.

20. The portable device of claim 14, wherein the portable device is a cell phone.
